(19) United States
(12) Patent Application Publication
(10) Pub. No.: US 2019/0044097 A1
(43) Pub. Date: Feb. 7, 2019

(54) REFERENCE ELECTRODE STRUCTURES FOR LITHIUM CELLS

(71) Applicant: GM GLOBAL TECHNOLOGY OPERATIONS LLC, Detroit, MI (US)

(72) Inventors: Zhiqiang Yu, Shanghai (CN); Samson Wu, Shanghai (CN); Xiaochao Que, Shanghai (CN); Helen Liu, Shanghai (CN)

(21) Appl. No.: 16/074,799

(22) PCT Filed: Mar. 18, 2016
(86) PCT No.: PCT/CN2016/076675

§ 371 Date: Aug. 2, 2018

(51) Int. Cl. H01M 2/02; H01M 10/0525; H01M 2/16; H01M 2/20; H01M 4/485; H01M 4/58; H01M 4/66; H01M 10/04; H01M 10/0585; H01M 10/0587; H01M 10/48

(52) U.S. Cl. CPC H01M 2/0207; H01M 10/0525; H01M 2/1673; H01M 2/202; H01M 4/485; H01M 10/482; H01M 4/661; H01M 10/0413; H01M 10/0585; H01M 10/0587; H01M 4/5825

(57) ABSTRACT

Some lithium-ion batteries are assembled using a plurality of electrically interconnected battery pouches to obtain the electrical potential and power requirements of the battery application. Such battery pouches may be prepared to contain a stacked grouping, or a wound grouping, of inter-layered and interconnected anodes, cathodes, and separators, each wetted with a liquid electrolyte. A reference electrode, an optional auxiliary reference electrode, and adjacent enclosing modified working electrodes are combined in a specific arrangement and inserted within the stack structure, or the wound structure, of other cell members to enable accurate assessment of both anode group and cathode group performance, and to validate and regenerate reference electrode capability.

### TECHNICAL FIELD

Some lithium-ion batteries are assembled using a selected number and arrangement of electrically interconnected battery containers, often cans or pouches, each can or pouch containing a like, stacked or rolled grouping of inter-layered and interconnected anodes, cathodes, and separators, and permeated with a liquid electrolyte. In accordance with this disclosure, a reference electrode, or a reference electrode and an auxiliary reference electrode, is combined in a specific arrangement with other cell members to enable accurate assessment of pouch performance, and to validate and regenerate reference electrode capability.

### BACKGROUND OF THE INVENTION

Assemblies of lithium-ion battery cells are finding increasing applications in providing motive power in automotive vehicles and in other electric power requiring applications. They are formed by stacking electrode and separator members and by winding electrode and separator members. They are formed in prismatic and cylindrical shapes and are contained in pouches or metal cans. Lithium-sulfur cells, lithium-air cells, sodium sulfur cells, and lithium-ion utilizing capacitors are also candidates for such applications.

In the case of lithium-ion batteries each lithium cell of the battery is capable of providing an electrical potential of about three to four volts and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric load, such as a traction motor for a vehicle. In a lithium-ion battery application for an electrically powered vehicle, the assembled battery may, for example, comprise up to three hundred cells that are electrically interconnected to provide forty to four hundred volts and sufficient electrical power to an electrical traction motor to drive a vehicle. Sometimes, predetermined groups of lithium-ion cells are placed in like-shaped pouches, cans, or like packages for assembly and interconnection in forming a specified battery voltage and power requirement. The direct current produced by the battery may be converted into an alternating current for more efficient motor operation.

The batteries may be used as the sole motive power source for electric motor driven electric vehicles or as a contributing power source in various types of hybrid vehicles, powered by a combination of an electric motor(s) and hydrocarbon-fueled engine. There is a desire to reduce the cost of producing the respective elements of each lithium-ion electrochemical cell. And there is a continual desire to improve the function and reliability of each element of the battery.

A lithium-ion cell, or a group of such cells, may also require the addition of a reference electrode, composed for use in assessing the performance of the cell during its repeated discharge/re-charge cycling. There is a need for improved design, placement, and employment of a reference electrode in lithium-ion batteries. And there is a need for the improved design, placement, and employment of a reference electrode in some association with pouches or other packages of assembled cells that are combined and interconnected in the assembly of a battery.

### SUMMARY OF THE INVENTION

This invention provides an arrangement of a grouping of lithium-ion anode and cathode cell units, with a reference electrode and, optionally, an auxiliary reference electrode, for incorporation into a self-contained battery pouch or like package. In some groupings of the cell units a long separator strip is wound between a predetermined number of like-shaped (often rectangular) flat alternating anode and cathode electrode layers for forming a stacked assembly of many cell units. In another embodiment, two long separator strips are wound with long anode and cathode strips to form a wound lithium-ion cell in a cylindrical or prismatic configuration. In accordance with practices of this invention, a reference electrode, or the combination of a reference electrode and an auxiliary electrode are formed and placed within a stack or roll of the working electrodes and their separator(s). The reference electrodes are strategically located in proximity to a specifically constructed grouping of cell units, and to share contact with a common liquid electrolyte when the grouping of cell elements has been placed in a container such as a battery pouch.

The battery pouch for a grouping of stacked electrodes may, for example, be rectangular in shape with an anode group terminal, a cathode group terminal, a first reference electrode tab, and an auxiliary reference electrode tab, each extending outwardly from the top or other selected side of the pouch.

The battery container for rolled cell elements may be round or prismatic in configuration.

The battery pouch (or like package) may be combined with other like pouches in the assembly of a battery with specified electrical potential and power requirements for a vehicle application or other electrical load application. In the assembly of such a battery, a selected number of like pouches may be placed in a suitable container and appropriate electrical connections made between anode and cathode terminals of the pouches. The connector tabs for the reference electrode and auxiliary electrode in each pouch are used, as described herein, to assess the performance of the electrically parallel connected anodes and parallel connected cathodes in the pouch to manage their contribution to the performance of the battery. Typically, a computer-based control system is used to manage the discharging and re-charging of the electrochemical cells of the battery. Such a computer-based control system may be programmed and used to manage high impedance connections (that draw a very low current) between a reference electrode and the anode and cathode terminals of each battery pouch.

In accordance with a stacked cell embodiment of this invention, a plurality of cell elements are prepared as like-shaped individual sheets for grouping, stacking, and placement in an accommodatingly shaped, thin, flexible wall pouch, formed of aluminum foil and coated on each side with an electrically insulating layer of a suitable polymer composition. In many embodiments of the invention it is preferred that the cell element sheets and their pouch container be of complementary rectangular shapes. In the rolled cell embodiment of this invention, the roll of cell elements is placed in a like round or prismatic pouch.

Each lithium-ion cell typically comprises a negative electrode layer (anode, during cell discharge), a positive electrode layer (cathode, during cell discharge), a thin porous separator layer that is interposed in face-to-face contact between parallel faces of electrode layers, and a non-aqueous liquid, lithium ion-containing, electrolyte solution infiltrating, permeating, and filling the pores of the separator and contacting porous facing surfaces of the electrode layers for transport of lithium ions during repeated cell discharge and re-charge cycles. Each electrode is prepared to contain a layer of an electrode material, deposited on one or both sides of a thin layer (e.g., a foil) of a metallic current collector. The current collector is formed with an uncoated tab, often located on the intended top side of the metal foil, for electrically connecting the electrode to another electrode in the assembly of the cell members of a lithium-ion battery pouch.

In an illustrative example, negative electrode material may be formed by depositing a thin layer of graphite particles, often mixed with conductive carbon black, and, optionally, a suitable polymeric binder onto one side or both sides of a thin foil of copper that serves as the current collector for the electrons flowing from the negative electrode during cell discharge. The positive electrode also comprises a thin layer of resin-bonded, porous, particulate lithium-metal-oxide composition bonded to a thin foil of aluminum that serves as the current collector for the positive electrode. Thus, the respective electrodes may be made by fixing, depositing, or bonding suitable electrode particles to their respective current collector surfaces. Depending on an intended arrangement in an assembled stack-up of electrodes, it is often desired to apply thin layers of electrode material to both sides or faces of a metal current collector foil.

In a first embodiment of the invention, a plurality of lithium-ion cell units are assembled in the form of a stack of thin, complementarily-sized and like-shaped sheet members for placement in a polymer-coated, metal pouch. Preferably an anode electrode is located at each end of the stack. For example, fourteen rectangular sheets of graphite/carbon anode material layers resin bonded onto both faces of individual non-porous copper current collector foils. And thirteen, slightly smaller, rectangular sheets of lithium (cobalt-manganese-nickel) oxide cathode material layers applied on both faces of non-porous aluminum current collector foils may be used. The copper foils are often used in thicknesses of about ten micrometers (suitably six to twenty micrometers), the aluminum foils in thicknesses of about twenty micrometers (suitably ten to thirty micrometers), and the respective active electrode materials are typically applied to a uniform thickness of about sixty micrometers to one or both faces of each foil. Typically, the anode layers are required to “cover” the cathode layers and so the heights and lengths of the rectangular anodes are slightly greater than the corresponding dimensions of the cathodes. A pouch may, for example, comprise five to sixty pairs of such anodes and cathodes (plus one extra anode).

The predetermined number of pairs of two-side coated anodes and cathodes may be varied depending on the desired electrical potential and electrical power of the stack (plus an anode at each end of the stack). The two-sided anode sheets and cathode sheets are stacked alternately (starting and ending with an anode) with coextensive rectangular porous separator sheet layers between each electrode and lying against an active material-coated face of each electrode. Often, the separator sheet is prepared as a strip of suitable length, which is folded back and forth between the coated faces of the alternating anode sheets and cathode sheets assembled in the stack. The separator sheet may, for example, be formed of a porous polyolefin (polyethylene, polypropylene, or mixtures or copolymers). Thus, in this initial stack, a two-side coated anode sheet occupies each end of the assembled linear stack. Where, for example, this initial stack is to include fourteen two-sided anode sheets alternating with thirteen two-sided cathode sheets, there will be a separator sheet strip with twenty-six folded separator surfaces included in the assembled stack with a separator sheet surface between each facing anode and cathode surface. But in order to utilize a reference electrode, or a reference electrode and an auxiliary electrode, in accordance with this invention, one or more working anode and/or cathode members in the stack will be modified before the assembled stack, with its reference electrodes, is ready for placement in its pouch container.

Illustrations of practices of the invention will be presented using both reference electrodes with the understanding that, in some cells, the auxiliary reference electrode may not be required or desired.

The reference electrode and auxiliary electrode may be placed side-by-side (with an interposed porous separator layer and outer separator layers) at any desired location within a stack of electrodes (someplace between the ends of the stack of alternating electrodes), suitably as the cell stack is being assembled. For example, in a stack of fourteen two-sided anodes alternating with thirteen two-sided cathodes (normally with their intervening, long, folded separator layer) it may be determined to place the reference electrodes in the middle of a contemplated, initially twenty-seven working-electrode stack-up. Other locations within the intended stack may be chosen. At any such intermediate location in the preliminary stack, under assembly, a current collector foil coated on both faces with uniform porous layers of active anode material would be intended to face (with an intended intervening porous separator layer) a current collector foil coated on both faces with uniform porous layers of cathode material.

The arrangement of the stack being assembled is modified at the selected point of insertion of a reference electrode and an auxiliary electrode. The reference electrode and auxiliary electrode may be placed between any intermediate pair of anode and cathode in the stack. But it is preferred to employ a modified cathode structure and anode structure on each side of the inserted reference electrode, or inserted reference electrode and auxiliary reference electrode.

When, for example, the reference electrode is to be placed next to a working cathode within the stack, the structure of the cathode is modified or revised. A revised cathode is formed or modified for placement between the opposing adjacent regular anode and the to-be-inserted reference electrode (with a separator on both sides). If the reference electrode is to be placed next to a regular working anode, then a revised anode would be substituted for location next to its adjacent opposing cathode. This revised cathode (in this example) is characterized as a Working Electrode 2 in the following text of this specification. Then, when an auxiliary electrode is to be placed or inserted within the stack of regular working electrodes, the auxiliary reference electrode will also be placed against a revised working electrode (Working Electrode 1) of the opposite charge with respect to Working Electrode 2.

As stated, a porous separator sheet (as employed in the stack) is placed against the regular two-sided anode layer member (in this example) at the intermediate location within the stack under assembly in which the reference electrode is to be placed. Working Electrode 2 (a revised cathode in this example) will then be prepared and placed to serve as a modified cathode. A suitable current collector foil (e.g., an aluminum foil) is employed, but the current collector foil is formed with a predetermined number of holes extending through its thickness. One side only of the porous (or hole-containing) current collector is coated with cathode material, suitably the same material used in the other cathodes of the stack. This Working Electrode 2 is placed with its coated side of cathode material lying against the separator sheet and facing toward the normal two-side coated anode member located at the location of the stack intended for the reference electrodes. The active cathode material of this inserted Working Electrode 2 is suitably the same as the cathode material in the other thirteen working cathodes. But, as stated, this current collector foil is prepared with small holes or pores extending through the thickness of the foil from one face through its opposing face. The small pores or holes are distributed over the facial area of the aluminum foil in a proportion of hole or pore area to the rectangular outline area of the foil so as to provide pathways over the face of the foil suitable for infiltration and permeation with a liquid lithium-ion containing electrolyte. The diameter of the holes or pores is suitably in the range of about (0.0001 mm to 1 mm). The area of the holes or pores may be up to about ninety-eight percent of the outline area or superficial area of the foil surface.

Similarly, a separator sheet is placed against the regular working two-sided cathode sheet at the other side of the location in the stack in which the reference electrodes are to be placed. If an auxiliary reference electrode is to be inserted onto the stack, a Working Electrode 1, in this illustration a revised anode, will be formed and inserted into the stack against the separator sheet. An aluminum or copper current collector foil, coated on one side or both sides with anode material used in the battery, is placed with a coated side lying against the separator sheet and facing toward the normal working two-side coated cathode member located at the location of the stack intended for the reference electrodes. The active anode material of this inserted Working Electrode 1 is suitably the same as the anode material in the other fourteen working anodes. Similarly, when Working Electrode 1 is to serve as a cathode, it may be prepared using the cathode material used in the other cathode members of the stack. In Working Electrode 1 this current collector foil does not require holes or pores extending through the thickness of the foil. If Working Electrode 1 is coated on only one side, the uncoated side is to face the reference electrode. This arrangement of Working Electrode 2 and, optionally Working Electrode 1 when there is an auxiliary reference electrode, is devised to accommodate the two reference electrode members

A layer of porous separator material is folded or placed over the uncoated current collector surfaces of Working Electrode 1 and Working Electrode 2.

A reference electrode may be prepared as follows for placement next to a Working Electrode 2, or a reference electrode and an auxiliary electrode may be prepared for placement between a Working Electrode 1 and Working Electrode 2.

In embodiments of this invention, the reference electrode is preferably prepared using either lithium iron phosphate (empirical formula, Li_{0.5}FePO₄) or lithium titanate (empirical formula, Li_{5.5}Ti₅O₁₂) as the reference electrode material. The composition of the lithium iron phosphate may vary as Li₁₋ₓFePO₄, where 0<x<1, as long as the electrochemical potential of the reference electrode is in a flat voltage plateau. It is preferred that both reference electrode and an auxiliary electrode display a flat voltage plateau during operation of the pouch cell so as to enhance variations in the potentials of the anodes and cathodes in the cell. The composition of the lithium titanate may vary as Li₄₊ₓTi₅O₁₂, where 0<x<3, as long as the electrochemical potential of the reference electrode is in a flat voltage plateau.

When an auxiliary electrode is used, its active electrode material is opposite to the electrode material used in the reference electrode. The active electrode material used in the auxiliary electrode may be like that used in a regular working electrode. For example, when the reference electrode material is lithium titanate (Li₄₊ₓTi₅O₁₂), an anode material, then the auxiliary reference electrode material is preferably LiMn₂O₄ (LMO), Li(NiₓMn_{y}Co_{z})O₂, x+y+z=1 (NMC), or LiFePO₄ (LFP). When the reference electrode material is lithium iron phosphate (Li₁₋ₓFePO₄), a cathode material, then the auxiliary electrode material may, for example, be graphite.

In preparing the reference electrode, the reference electrode material is typically applied in a porous particulate layer (permeable by liquid electrolyte) of substantially uniform thickness (e.g., about 60 micrometers) to one side or face of a compatible current collector foil. The surface shape and size of the current collector foil may be of substantially the same size and shape as the rest of the stack of cell materials, or it may be of a different size and shape that is compatible for insertion in the stack.

In the preparation of the auxiliary electrode, the coating may be applied to one or both sides of its compatible current collector foil. If only one side of an auxiliary electrode is coated, that coated side is to face the reference electrode.

When the reference electrode is used alone, no holes are formed in its current collector foil. No through-holes are introduced into the current collector foil of an auxiliary electrode or of a Working Electrode 1. When the reference electrode is used in combination with an auxiliary reference electrode, through holes or suitable pores are formed in the reference electrode current collector foil before or after it is coated with the reference electrode material.

When the reference electrode material is Li₁₋ₓFePO₄, an aluminum current collector foil is used. When the reference electrode material is Li₄₊ₓT₅O₁₂, an aluminum or copper current collector foil is used.

The reference electrode member is placed against and coextensive with the porous separator member, and opposing, one-side coated (opposite side) Working Electrode 2. Another porous separator sheet is placed against the outer coated side of the reference electrode and a like coated and sized, auxiliary reference electrode is placed against the separator. A third porous separator sheet is placed against the opposing reference electrode material coated side of the auxiliary reference electrode member. And the uncoated side of the no hole-containing current collector of a one-side coated Working Electrode 1 is placed against the porous separator. The remainder of the stack of lithium-ion cell electrodes, with a porous separator at the touching end is assembled against the coated side of Working Electrode 1 to complete the assembly of the cell group and its interposed reference electrode and optional auxiliary electrode.

The reference electrode current collector and an auxiliary reference electrode current collector have tabs at their top sides for interconnection with each other and with anode group and cathode group terminal elements of the stack of cell materials.

The upstanding current collector tab members of each of the assembled stack of anode members (fifteen anode members, including Working Electrode 1, in this example) may be joined in electrical parallel connection to an anode group terminal strip. The tab members of the cathode members (fourteen cathode members, including Working Electrode 2, in this example) may likewise be separately joined to a cathode group terminal strip. The respective tab members are of predetermined length to accommodate the joining of the several tabs and it may be preferred to accomplish the joining and the attachment of the group electrode terminal near the middle of the stack.

The upstanding connector tabs on the main reference electrode and auxiliary reference electrode stand alone, but within a connectable distance to the anode group terminal and the cathode group terminal. The dry assembled stack may now be placed in a suitable pouch with the electrode groups' terminals and reference electrode tabs extending in a parallel attitude, out of the unclosed opening of the pouch. A volume of liquid lithium-ion containing electrolyte is carefully placed or loaded into the pouch so as to fully wet the active material of each electrode (active and reference electrodes) and separator in the assembled stack. The liquid is typically a non-aqueous liquid. The electrolyte is applied so as to suitably infiltrate, permeate, and wet all intended electrode and separator surfaces without an unwanted excess of liquid. The pouch is suitably evacuated of unwanted gas or vapor, and closed and sealed over the cell materials and around the extending anode and cathode group terminals and the tabs of the two reference electrodes. Four conductive connector strips are thus exposed at a selected side of the sealed pouch.

Thus, the pouch of a predetermined plurality of cell units also contains a reference cell element and an optional auxiliary cell element, located side-by-side with an intervening separator, wetted by a common electrolyte, and positioned in the stack of cell electrodes for suitable testing of the anode group and cathode group members of the cell. The two complementary reference cells, if used together, are situated for use to validate each other. And the auxiliary reference electrode can be charged or discharged, using the active cell members, to regenerate the principal reference electrode. The location of the reference electrodes in close proximity to Working Electrode 1 and Working Electrode 2 is important in using the reference electrode to obtain accurate measurement of the anode group potential or the cathode group potential of the pouch elements.

In a second embodiment of the invention the lithium-ion cell is formed by winding strips of electrode materials and porous separators. A typical lithium-ion wound cell (without a reference electrode) typically contains one cathode electrode in the form of a strip, a separator strip, an anode strip, and another separator strip. Each strip is in the shape of a long rectangle of desired height. Each normal electrode strip has a central current collector foil coated on both sides with a layer of electrode material (anode or cathode). The respective electrode strips have a suitable length and width to provide the intended power requirements of the cell. The respective separator strips are sized to physically separate the two electrode strips. Initially, a cathode strip may be placed on a working surface. A separator strip is placed on the cathode strip. An anode strip is placed on the separator strip, and a second separator strip is placed on the opposite side of the anode strip. The four layers are wound so that the initially outer separator strip engages the exposed side of the cathode strip where the wound structures overlap. Suitable terminal tabs are placed at suitable locations on like sides of the anode and cathode strips. The four layers may be wound in the shape of a cylinder, or they may be wound with flat major surfaces and rounded sides. The anode and cathode terminals typically extend from the same side of the wound cell shape. The wound strips are placed in a suitable polymer coated, flexible metal pouch. As described in more detail above in this specification, the wound assembly is infiltrated with a suitable electrolyte and the pouch is closed with the electrode terminals extending through the pouch wall or top surface. In accordance with this embodiment of the invention, a reference electrode and, optionally, an auxiliary reference electrode are placed at the center of the wound cell core or at the outer layer of the wound cell core.

A relatively small reference electrode and, optionally, a like-sized auxiliary electrode are prepared and suitably sized for insertion as flexible flat or wound layers at a relatively short location with and between the working electrode strips as they are carefully wound to form the self-sustaining lithium-ion cell. The respective layered structures and compositions of the reference electrode and the auxiliary electrode, if used, may be like those described in this text for insertion in the stacked cells. And arrangements are made for the adaptation or placement of a Working Electrode 1 and Working Electrode 2 as described in the above and following portions of this specification. Small portions of the wound cathode and anode layers may be adapted as a Working Electrode 1 and Working electrode 2. Or a separate Working Electrode 1 and/or a separate Working electrode 2 may be prepared and inserted with a reference electrode or a reference electrode and an auxiliary reference electrode into the wound cell layers.

Thus, a specific reference electrode structure and, optionally, an auxiliary reference electrode structure are provided for use in either a lithium-ion battery formed of a stack of electrode and separator members or one formed of wound strips of electrode and separator members.

The subject reference electrode compositions and structures and their combination with a subject auxiliary reference electrode composition and structure may also be placed used in lithium-ion capacitors, lithium air cells, lithium sulfur cells, and sodium sulfur cells in both wound and stacked electrode cell cores and placed in pouches or metal cans.

Other objects and advantages of this invention will be apparent from a detailed description of preferred embodiments which follow in this specification.

### BRIEF DESCRIPTION OF THE DRAWINGS

FIG. 1 is an oblique view of a stack of active electrode elements with interposed separator elements for a lithium-ion battery cell, as viewed from the right end toward the left end of the illustration, with a reference electrode element and an auxiliary reference electrode element inserted in an intermediate location between the ends of the stack. The illustration is expanded at a central location within the active electrode portion of the stack to show the structure and organization of the reference electrode and auxiliary electrode. And the illustration of the stack is expanded on both sides of the location of the reference and auxiliary electrodes to better describe the structure and organization of Working Electrode 1 and Working Electrode 2. Thus, FIG. 1 illustrates a stack of lithium-ion cell members with both expanded and un-expanded portions of the stack. Of course, in use, no portion of the stack is expanded.

FIG. 2 is an illustration of the stack of FIG. 1 with the members of the stack lying in their face-to-face positions. FIG. 2 shows the elements of stack with one example of the positioning of active cell terminals and reference cell tabs. The reference electrode and its auxiliary electrode and adjoining Working Electrodes 1 and 2 are illustrated at their location in the middle of the stack. A couple of pairs of an anode member and cathode member within the stack are shown in more detail than adjacent anodes and cathodes in the stack. The stack is illustrated as ready for placing in a pouch container and for infiltration with a liquid, lithium-ion cell electrolyte.

FIG. 3 is an illustration of a pouch container, filled with the stack elements of FIGS. 1 and 2, and a non-aqueous liquid electrolyte. The pouch may be combined and assembled with other like pouch cell containers in the making of a lithium-ion battery. The anode group and cathode group connector terminals extend from the top of the pouch for connection with other terminals in a battery assembly. The reference electrode tad and auxiliary electrode tab are positioned for connection with an electrode terminal of the pouch container or with each other.

FIG. 4A is a schematic illustration of a lithium-ion battery formed of wound layers of a cathode, a separator, an anode, and a separator with a relatively small layered assembly of a reference electrode and an auxiliary electrode inserted at the core or center of the wound strips of electrode materials. In FIG. 4A the four strip member layers are shown with spacing between the wound layers for better visibility of the wound structure.

FIG. 4B is an enlarged schematic illustration of the assembly of reference electrode, auxiliary electrode, Working Electrode 1, and Working Electrode 2 as placed in the wound battery assembly illustrated in FIG. 4A.

### DESCRIPTION OF PREFERRED EMBODIMENTS

Some types of relatively large lithium-ion batteries are made by preparing packages or pouches of, for example, ten to thirty pairs of alternating anode members and cathode members, separated from direct electrical contact by porous, electrically insulating, separators. A suitable number of such pouches are assembled in a battery container and electrically connected to form a desired battery. It is typically desired to provide reference electrodes to assess the performance of the individual pouches and of the assembled battery. In accordance with practices of this invention, the organization and arrangement of a reference electrode and an auxiliary reference electrode and the active members of lithium-ion cells in a pouch is important.

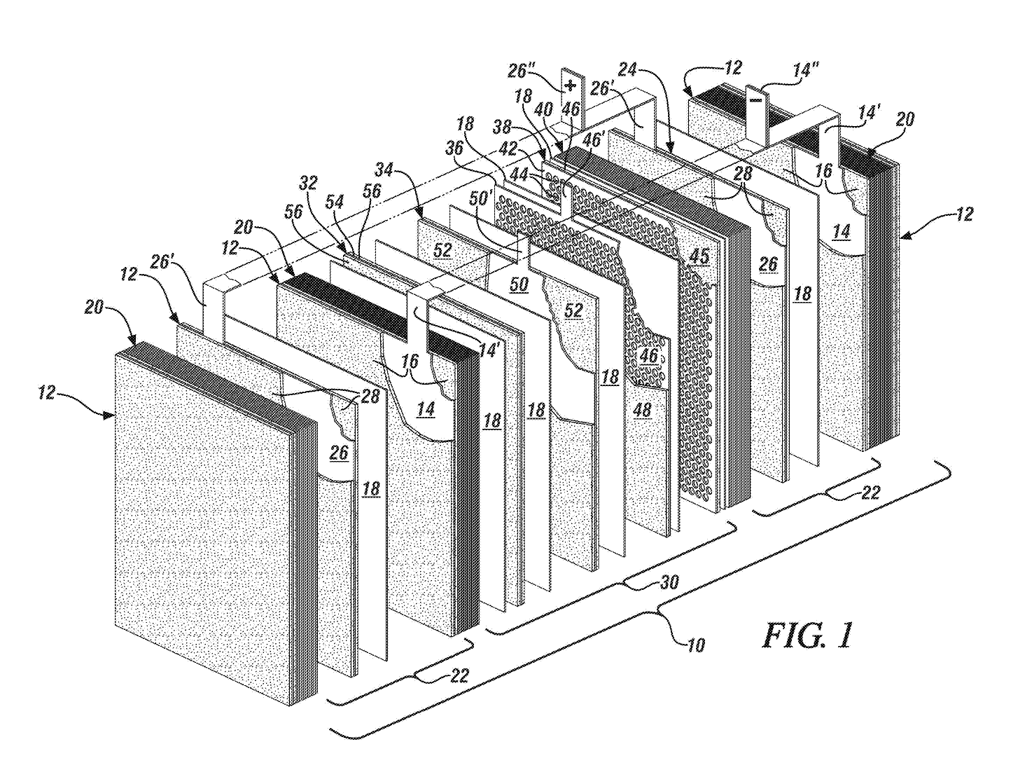

FIG. 1 illustrates a first embodiment of this invention in which like-shaped electrode layers are stacked with a wound intervening porous separator strip, or with individual porous separator layers. A back-and-forth wound separator layer is often used, but the illustration of FIG. 1 is simplified by showing the separator as individual separator layers.

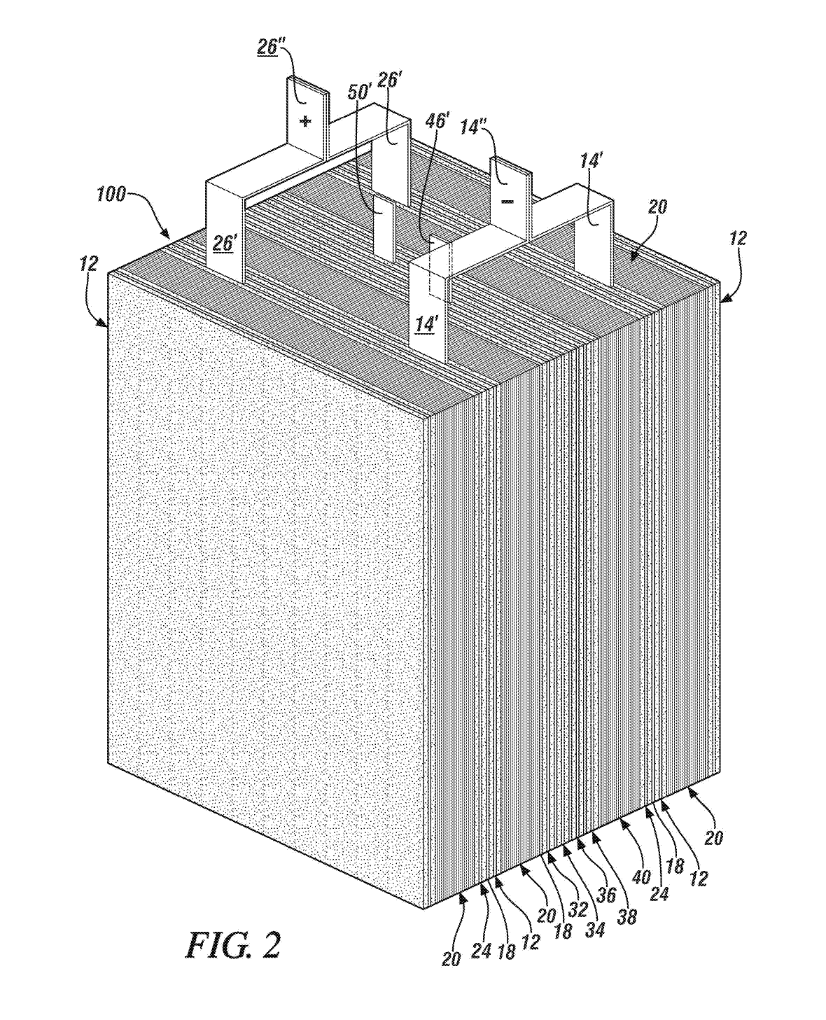

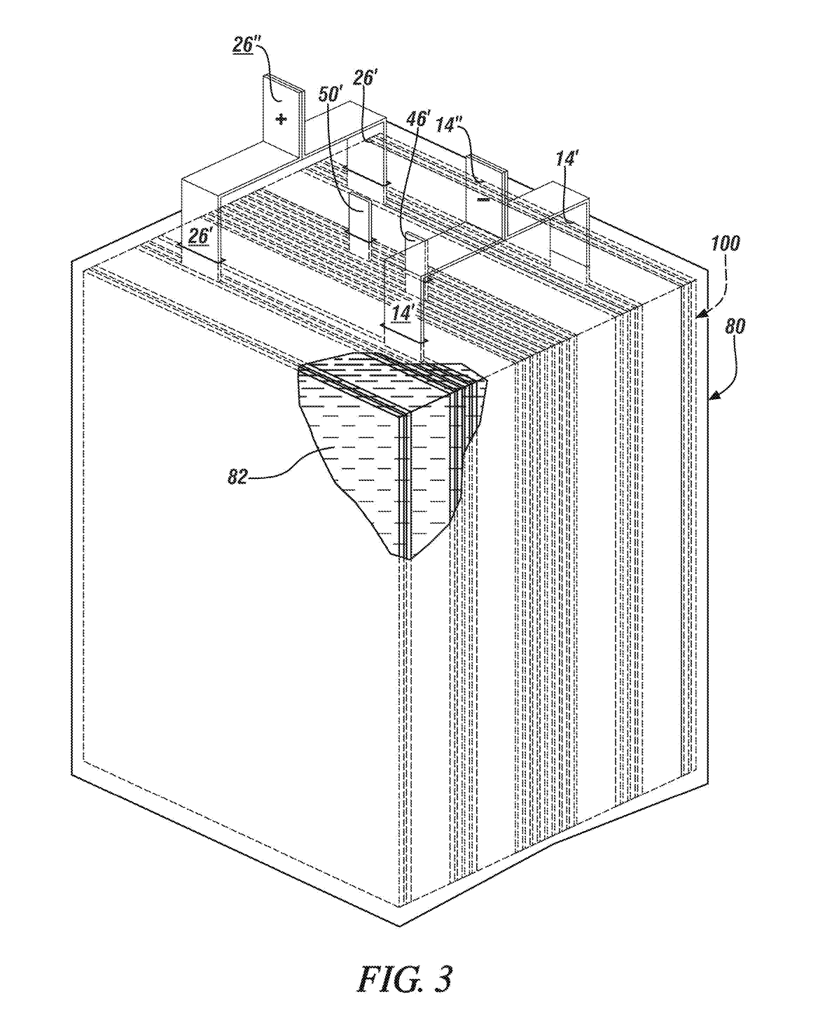

In a typical battery pouch of this illustration, the ten to fifteen pairs of the respective cell members are of generally flat, rectangular shape (like playing cards) and assembled face-to-face like a stack of playing cards. Such an arrangement is illustrated in FIGS. 2 and 3, which will be described in more detail in later paragraphs of this specification. But in FIG. 1 some of the members of stack 10 of cell members are spaced-apart for illustration of their structure and arrangement, while other members are placed in their normal stack position. The illustrated expanded openings 22 of stack 10 as depicted in FIG. 1 is for purposes of better showing the structures and locations of ordinary working anode 12 and cathode 24 members in a stack arranged in accordance with this invention. Further, expanded opening 30 is used to describe and illustrate the structures and locations of inserted Working Electrode 2 (38), reference electrode 36, optional auxiliary electrode 34, and Working Electrode 1 (32).

At both ends of stack 10 are anodes 12 each of which is followed inwardly by a porous separator and a cathode. As illustrated at illustrative openings 22 in the stack 10, each repeated working anode 12 has a rectangular shape. It is formed of a non-porous copper foil 14 which serves as a current collector for the anode material. Each anode current collector foil has a tab 14′ of suitable length which enables it to be connected to each of the other like anodes 12 in the stack 10 in a common negative terminal 14″. In order to simplify the illustration in FIG. 1 only two of the anode current collector tabs 14′ are shown. The anode copper foil current collector 14 is typically about ten micrometers thick. The copper current collector foil 14 is coextensively coated on both sides with an active anode material 16 (such as commercially available MesoCarbon MicroBeads graphite, MCMB or surface modified graphite, SMG) that is suitable for a lithium-ion cell anode. The thickness of each layer of active anode material may be about sixty micrometers. As stated, each copper foil current collector tab 14 is sized to enable each anode 12 to be electrically connected in parallel connection to the other anodes in the stack 10.

In each expanded portion 22 of stack 10 of FIG. 1, a separator 18 is positioned next to active anode material layers 16 of anode 12. And next to separator 18 is a cathode 24. While this expanded portion of stack 10 permits the illustration of a representative cathode 24, it is to be understood that each cathode 24 is substantially identical in size, shape, and structure, except, perhaps for the retained length of their uncoated connector tabs 26′. Each cathode 24 comprises a thin, non-porous aluminum foil 26 as its current collector substrate. Each side of the aluminum current collector foil 26 is coated or covered suitable active cathode materials 28. A suitable cathode material is Li(Ni_{1/3}Mn_{1/3}CO_{1/3})O₂. In general, examples of suitable cathode materials include particles of lithium-metal-oxide compounds or compositions, such as lithium-manganese-oxide, lithium-nickel-oxide, and/or lithium-cobalt-oxide.

The respective active electrode materials are often used in the form of suitably sized particles that can be resin bonded to form the respective electrode layers typically applied to both sides of their respective metal (usually aluminum or copper) foil current collectors. So the electrode layer may comprise suitable particles of active electrode material, a binder material, and sometimes particulate conductive additives. Examples of suitable binders include polyvinylidene fluoride (PVDF), carboxymethyl cellulose with styrene butadiene rubber (CMC+SBR), polytetrafluoroethylene (PTFE), and polyacrylonitrile in water (LA132, LA133). Examples of conductive additives conductive carbon, graphite, vapor grown carbon fibers, and carbon nanotubes. The binder and conductive additives may make up about one to twenty weight percent of the active material, binder, conductive additive mixture.

Again, the uncoated cathode connector tabs 26′ on most of the thirteen cathodes are not illustrated to simplify FIG. 1. But the respective cathode connector tabs 26′ are trimmed or sized to be connected to a centrally located terminal 26″ to interconnect each of the cathodes 24 and to form a cathode group terminal.

Numeral 20 refers to representative illustrated non-expanded stack portions of a cathode, a separator, an anode, a separator, etc. in stack 10 of FIG. 1. As described above, each active cell electrode member is placed, face to face, next to a complementary active cell electrode member with an intervening porous separator. The stack portions represented by numeral 20 represent a few groups of cell member groupings.

A further expanded portion 30 (for purposes of illustration) in a central location in stack 10 of FIG. 1 is used to illustrate the locations and structures of Working Electrode 1 (32), auxiliary electrode 34, reference electrode 36, and Working Electrode 2 (38).

As described, proceeding from the right end of stack 10 as illustrated in FIG. 1 is an alternating sequence of layers of regular working anodes 12, separators 18, and regular working cathodes 24. A working anode 12 is located at each end of stack 10. Reference electrode 36 may be inserted at a predetermined desired location during the assembly of the layered members of stack 10. The last regular working electrode member before the placement of reference electrode 36 may be an anode or cathode. For purposes of illustration, it is assumed that a cathode is to be the last regular working electrode before the placement of the reference electrode 36. A porous separator 18 would be placed against the active cathode material layer of the cathode layer. The cell layer members would be located at the left side of sub-stack 40 in FIG. 1. Then a specially constructed Working Electrode 2 (38) would be placed against porous separator layer 18 at the left end of sub-stack 40.

In this example, Working Electrode 2 (38) will then be prepared and placed to serve as an anode. A suitable current collector foil 42 (e.g., a copper foil) is employed with a suitable number of holes 44 extending through its thickness. One side only of the porous current collector foil 42 is coated with anode material 45, suitably the same material used in the other anodes of the stack. This Working Electrode 2 (38) is placed with its coated anode material side 45 lying against the separator sheet 18 and facing toward the two-side coated cathode member located at the location of the stack intended for the reference electrodes. The uncoated side of the hole-containing current collector foil 42 of Working Electrode 2 (38) will face the reference electrode 36. The current collector foil 42 will typically contain a connector tab (not illustrated in FIG. 1) for connection with the tabs 14′ of the other working anodes 12 in the stack 10.

The active anode material layer 45 of this inserted Working Electrode 2 (38) is suitably the same as the anode material in the other several regular working anodes 12 of stack 10. But, as stated, this copper current collector foil 42 is prepared with small holes 44 or pores extending through the thickness of the foil from one face through its opposing face. The small pores or holes 44 are distributed over selected portions of the facial area of the copper foil 42 in a proportion of hole or pore area to the rectangular outline area of the foil so as to provide pathways over the face of the foil 42 suitable for infiltration and permeation with a liquid lithium-ion containing electrolyte. The diameter of the holes or pores is suitably in the range of about (0.0001 mm to 1 mm). The area of the holes or pores may be up to about ninety-eight percent of the outline area or superficial area of the foil surface.

Porous copper foils and aluminum foils are commercially available for other applications. The porous copper current collector foil 42 may, for example, be formed by forming laser-cut holes or by punching holes in a dense copper foil. A laser beam can cut holes as small as about one micrometer in copper foil that is about ten micrometers thick. The sizes of the holes may be in the range of about one micrometer to about one millimeter. The porosity of the copper current collector is to enable liquid electrolyte to flow through the current collector foil 42, just as the electrolyte permeates the anode material 45. Suitably, the pore area 44 of current collector foil 42 is in the range of about 0%<x<98% of the outline rectangular face area of the copper current collector foil 42.

As illustrated in FIG. 1, a separator 18 is placed against the porous copper current collector foil 42 of Working Electrode 2 (38). A reference electrode 36 is then stacked against separator 18.

Reference electrode 36 is suitably prepared using either lithium iron phosphate (empirical formula, Li_{0.5}FePO₄) or lithium titanate (empirical formula, Li_{5.5}Ti₅O₁₂) as the reference electrode material. The reference electrode material 48 is applied to one side only of a current collector foil 46. If reference electrode 36 uses lithium iron phosphate as the electrode material 48, an aluminum current collector foil 46 may be used. If reference electrode 36 uses lithium titanate as the applied electrode material layer 48, either an aluminum or a copper current collector foil 46 may be used. When reference electrode 36 is used in a stack with no auxiliary electrode, the current collector foil contains no holes or pores and the side of the non-porous current collected that is coated with reference electrode material is placed in the stack with its coated side facing Working Electrode 2. When reference electrode 36 is used in combination with an auxiliary electrode 34, as illustrated in FIG. 1, the current collector foil 46 of the reference electrode 36 contains holes as illustrated in FIG. 1. And the reference electrode material 48 coated side of the porous current collector foil 46 should face auxiliary electrode 34.

Thus, reference electrode 36 may comprise a porous aluminum current collector foil 46 which may be of substantially the same size and shape and porosity as the current collector foil 42 used in Working Electrode 2 (38). The porous aluminum current collector foil 46 for reference electrode 36 is coated on one side with a porous layer 48 of either lithium iron phosphate or lithium titanate as the active reference electrode material, the side facing Working Electrode 2 (38).

A porous separator layer 18 lies against the coated side (reference electrode material 48) of the hole-containing current collector foil 46 of reference electrode 36. The porous aluminum foil current collector 46 comprises a tab 46′ for enabling an electrical connection to an anode terminal (e.g., 14″ in FIGS. 2 and 3) or a cathode terminal (e.g., 26″ in FIGS. 1, 2, and 3) during evaluation of the performance of the anode group or cathode group of the stack.

An optional auxiliary reference electrode 34, which is substantially identical in shape to reference electrode 36, is placed against the separator 18 spacing it from reference electrode 36. Auxiliary electrode 34 comprises a solid (non-porous) aluminum or copper current collector foil 50 (or optionally copper, if a lithium titanate auxiliary reference electrode material is used) with a connection tab 50′. When an auxiliary electrode is used, its active electrode material is electrochemically opposite to the electrode material used in the reference electrode. The active electrode material used in the auxiliary electrode may be like that used in a regular working electrode. For example, when the reference electrode material is lithium titanate (Li₄₊ₓTi₅O₁₂), an anode material, then the auxiliary reference electrode material is preferably LMO, NMC, or LFP. When the reference electrode material is lithium iron phosphate (Li₁₋ₓFePO₄), a cathode material, then the auxiliary electrode material may, for example, be graphite. Auxiliary electrode material 52 is typically applied to both sides of its current collector foil, as shown in FIG. 1. But when current collector foil 50 is coated on only one side with electrode material 52, the coated side is to face the reference electrode 36.

Although auxiliary reference electrode 34 is similar, but complementary, in its electrode material composition to that of reference electrode 36, the optional auxiliary reference electrode 34 usually serves a different, but complementary, function with respect to the function of reference electrode 36. Electrical connector tab 46′ on reference electrode 36 is available for connection to either the positive terminal (26″ in FIGS. 1, 2 and 3) for the parallel connected anodes or the negative terminal (14″ in FIGS. 2 and 3) for the parallel connected cathodes—one at a time. Such a connection could be made by use of a connector and electrical meter provided in a fully assembled lithium-ion battery containing several pouches of cell elements and apparatus for managing charging and discharging of the battery.

Connector tab 50′ on auxiliary reference electrode 34 is typically connected to reference electrode tab 46′ when it is desired to calibrate or regenerate reference electrode 36. Such calibration or regeneration actions are often undertaken in an assembled battery, under use, by a computer controlled system for managing discharging and re-charging of the battery and its pouch members.

FIG. 2 illustrates the cell members of the stack 10 as illustrated in FIG. 1 as an unexpanded assembled stack 100. The members of the assembled lithium-ion cell stack 100 are illustrated in their intended and proper face-to face positions in the stack for assembly into a pouch container. The unexpanded stack 100 of FIG. 2 illustrates the locations of the anode members 12 at each end of the stack. It illustrates the locations of the portions of the stack 20, 40 described in the schematic illustration of FIG. 1. The illustration of the unexpanded assembled stack 100 of FIG. 2 also illustrates the locations of Working Electrode 1(32), optional auxiliary electrode 34, reference electrode 36, and Working Electrode 2 (38) in this example of an assembled stack 100. Projecting from the top of the assembled stack 100 are two representative anode current collector foil tabs 14′ as the several anode group tabs are gathered and interconnected as anode terminal 14″. Also projecting from the top of the assembled stack 100 in FIG. 2 are two representative cathode current collector foil tabs 26′ as an illustration of the gathering of the several cathode group tabs as cathode group terminal 26″. FIG. 2 also illustrates the up-standing tab 46′ of reference electrode 36. and the tab 50′ of the auxiliary electrode 34

After the respective active electrodes, reference electrodes, and interposed one-layer separators have been arranged in a stack as specified in this text, the stack is placed in a pouch container. The insertion of the stack into a pouch may be carried out in a managed air environment of ambient temperature, less than five percent relative humidity, and less than one bar pressure to accommodate suitable filling of the pouch and insertion of the selected electrolyte into the stack so that the lithium-ion containing liquid infiltrates, permeates, and fills all the intended pores and interstices of each member of the stack with no retained air or other unwanted gas in the stack. While still in this packaging environment, the pouch is closed around the lithium-ion cell members stack with the anode group terminal, the cathode group terminal, the reference electrode tab, and the auxiliary reference electrode tab extending though a surface pouch, with a suitable seal between the pouch wall and each of the electrical connectors to the stack within the pouch.

FIG. 3 is an illustration of the lithium-ion cell filled pouch. The stack 100 (as illustrated in FIG. 2 has been placed within pouch 80, and the top of the pouch 80 has been closed and sealed around anode group terminal 14″, cathode group terminal 26″, reference electrode tab 46′, and auxiliary reference electrode tab 50′. A portion of the pouch material is broken away and the dashed lines in FIG. 3 represent the presence of a liquid lithium-ion containing electrolyte 82 that wets surfaces of each active electrode member, each reference electrode member, and each separator in the assembled stack 100. Suitable pouch containers are commercially available. A suitable and preferred pouch material is polymer coated aluminum foil. The polymer coating comprises multiple layers and is applied to both sides of the aluminum foil in the pouch container.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and solvent is selected for providing suitable mobility and transport of lithium ions in the operation of the cell. The electrolyte is carefully dispersed into and between closely spaced layers of the electrode elements and separator layers.

In the above illustrated embodiments of the invention, each cell member of the stacked elements is rectangular in shape. In accordance with general practices of the invention the members of the stack do not have to be rectangular. But a rectangular stack in a rectangular pouch is a convenient shape for the assembly of a lithium-ion battery in many applications.

By way of illustration, without intention to limit the invention, a rectangular anode 57 mm in height and 52 millimeters in width may be used. Its connector tab would be located at the top side of its copper current collector foil near one vertical side to facilitate the electrical parallel connection of each of the anode foils in a stack. Typically, the thickness of the copper foil is in the range of about 6-20 micrometers, and the thickness of each coating of active material is about sixty micrometers. The thickness of the anode material is dependent on the electrochemical capacity required of it, and is typically in the range of about 10 micrometers to about 150 micrometers.

It is generally preferred that each anode layer “cover” the adjacent cathode layer and that the separator strip cover both electrodes. So each anode layer is slightly larger than the cathode layer and the separator strip is wider than the height of the anode. A complementary, suitable cathode, for example, may have a height of 55 millimeters and a width of 50 mm. Its connector tab would be located at the top side of its aluminum current collector foil near the other vertical side to facilitate the electrical parallel connection of each of the cathode foils in a stack. Typically, the thickness of the aluminum current collector foil for the cathode is in the range of about ten to thirty micrometers, and the thickness of each coating of active cathode material is about sixty micrometers. In this example, the separator strip is about 60 mm wide, so as to cover both the anode and cathode, and about 25 micrometers thick. The thickness of the cathode material is dependent on the electrochemical capacity required of it, and is typically in the range of about 10 micrometers to about 150 micrometers.

The height and width of rectangular anodes and cathodes is suitably in the range from ten millimeters to five hundred millimeters and the height and width of the anodes in a stack is slightly larger than the corresponding dimensions of the cathodes in the stack so that the anodes cover the cathodes. As stated the separator layer is sized to cover both the anode and cathode faces.

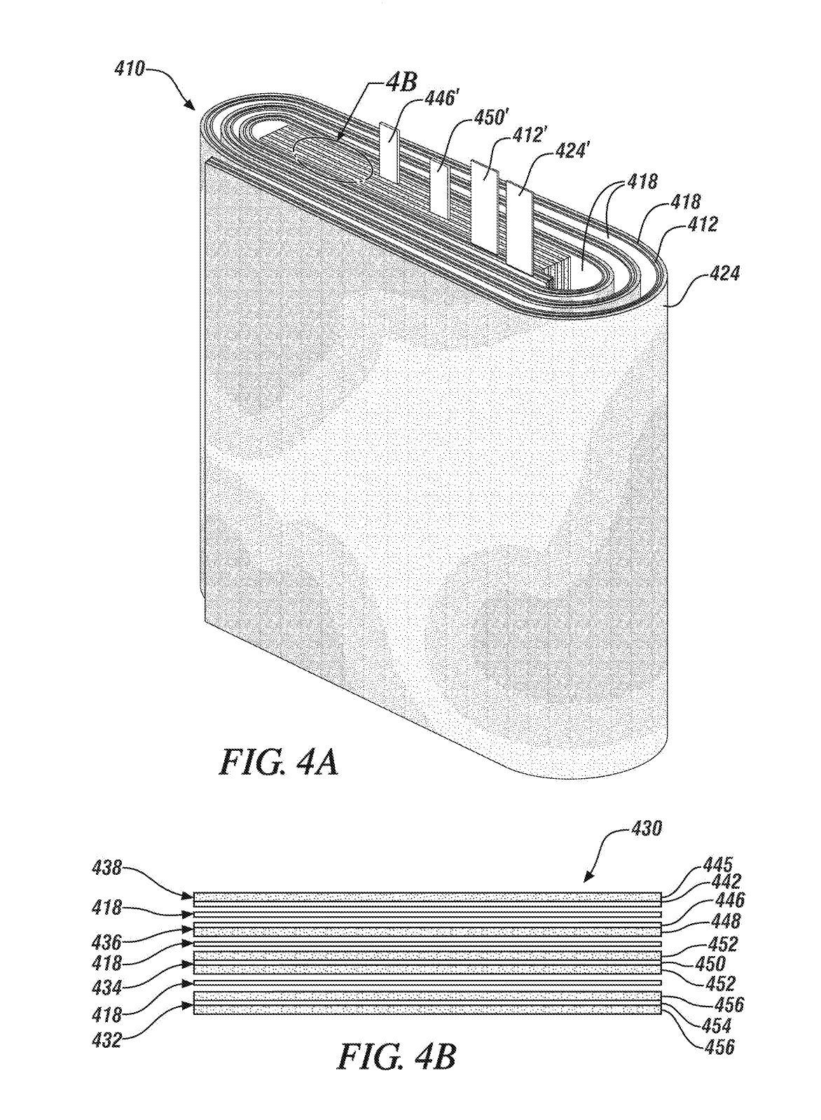

Reference is now made to FIGS. 4A and 4B for description and illustration of the placement of a reference electrode and an auxiliary electrode at the core of a wound lithium-ion cell structure 410.

Wound lithium-ion cell structure 410 is formed of four like-sized continuous strips. As illustrated in FIG. 4A, the strips are organized and placed with a first porous separator strip 418 as the inner layer. Lying next to the first separator strip 418 is a strip of anode material 412, a second porous separator strip 418, and, lastly, a strip of cathode material 424.

The continuous strip of anode material consists of three layers including a suitable current collector foil coated on both sides with like layers of resin bonded particles of anode material. The strip of anode material 412 has a terminal 412′, extending from its current collector foil strip, at a selected suitable location along its length. The composition and properties of the active anode material 412 are consistent with the description provided with respect to the anodes 12 in an above section of this specification with respected to the stacked lithium-ion cells.

Similarly, the continuous strip of cathode material 424 consists of three layers, including a current collector foil coated on both sides with like layers of resin bonded particles of cathode material. The strip of cathode material 424 has a terminal 424′, extending from its current collector foil, at a suitable location along its length. The composition and properties of the active cathode material may be the same as described with respect to the cathodes described above in this specification with respected to the stacked lithium-ion cells.

As illustrated in FIG. 4A, a reference electrode package 430 is inserted at the core (within the first winding) of the wound lithium-ion cell structure 410. A portion of this reference electrode package 430, as indicated at 4B, has been enlarged and spaced apart in FIG. 4B to better illustrate the seven layered members of the reference electrode package. The respective layers of the reference electrode package in this embodiment of the invention are like those described above with respect to the layered stack embodiment of our lithium-ion cell. They may have like compositions and similar structures that are compatible with the wound cell arrangement of this embodiment.

The spaced-apart and enlarged illustration of reference electrode package 430 in FIG. 4B depicts a like arrangement as illustrated in FIG. 4A, the upper side in FIG. 4A being the top side of FIG. 4B. In FIG. 4A, it is seen that both sides of the reference electrode package 430 are in face-to-face contact with the exposed separator layer 418 of the wound lithium-ion cell structure 410. The anode layer 412 of the wound lithium-ion cell structure 410 lies next to the inner separator layer 418.

The respective seven layers of the reference electrode package 430 (FIG. 4B) correspond generally to like members of the reference electrode package illustrated in FIG. 1. The last two digits of the identifying numerals of the layers of FIG. 4B correspond to the identifying numerals used in FIG. 1. The detailed descriptions provided above in this specification with respect to suitable compositions and structures for the Working Electrode 2 (38), the reference electrode 36, the optional auxiliary reference electrode 34, and Working Electrode 1 are applicable to the corresponding members of reference electrode package 450.

In FIG. 4B, the upper illustrated layer is a Working Electrode 2 (438) which is formed of a hole-containing current collector foil 442 coated on only one side with a porous layer of particulate cathode material 445. When the assembled reference electrode material package 450 is placed in the wound lithium-ion cell 410, the cathode material layer 445 is placed against a portion of the surface of the exposed separator strip layer 418. The porous layer of cathode material 445 of Working Electrode 2 (438) lies against a portion of the surface of the wound strip 418 of the wound lithium-ion cell 410. The anode strip layer 412 of wound lithium-ion cell 410 is immediately behind the inner separator strip as illustrated in FIG. 4A.

A suitably sized piece of separator layer 418 is placed against the hole-containing current collector foil 442 of Working Electrode 2 (438).

Reference electrode 436 is formed of particles of reference electrode material 448 deposited as a porous layer of substantially uniform thickness on one side of a hole-containing current collector foil 446 of suitable metal composition. The current collector foil 446 has a tab 446′ (in FIG. 4A) for use in making electrical connections with the lithium-ion cell electrode terminals (e.g., 412′ or 424′). The uncoated side of current collector foil 446 lies against separator 418, facing Working Electrode 2. A porous separator 418 is placed against reference electrode material layer 448 on the opposite side of current collector foil 446.

In this example, an auxiliary reference electrode 434 is employed in the assembled reference electrode package 430. It is placed against separator 418 lying against the reference electrode material layer 448, and lies next to the reference electrode 436. In this embodiment, auxiliary reference electrode 434 is formed of particles of auxiliary electrode material 452 deposited as porous layers on one or both sides of a non-porous current collector foil 450. The current collector foil 450 has a connector tab (450′ in FIG. 4A) for connection with the reference electrode 436 (Tab 436′ in FIG. 4A). A porous separator is placed against the opposite side of the auxiliary electrode 434 to physically separate it from Working Electrode 1 (432).

As illustrated in FIG. 4B, Working Electrode 1 is formed of two layers of resin-bonded particles suitable anode electrode material 456 formed on both sides of a non-porous current collector foil 454. One side of Working Electrode 1(432) faces the auxiliary reference electrode 434 and the other side of the Working Electrode 1 is placed against the wound portion of the inner separator strip 418 of the wound lithium-ion cell structure 410 (FIG. 4A).

As illustrated in FIG. 4A, the reference electrode package 430 was placed near one end of the wound assembly of the four strip layers of the wound lithium-ion cell 410. In another embodiment of this wound cell structure, the reference electrode package 430 may be placed just inside the outer end of wound layer of four strips.

In the above example, a seven layer reference electrode package 430 was inserted between the four wound layers 418, 412, 418, and 424 of a wound cell. Separate structures for a Working Electrode 1(432) and a Working Electrode 2 (438) were formed as part of the reference electrode package 430. In other embodiments of the invention, a suitably sized small portion of an individual anode layer 412 or cathode layer 424 of the wound cell 410 may be modified to serve as a suitable Working Electrode 2, and a reference electrode 436 or a reference electrode 436 and auxiliary reference electrode 434 placed with one or more separator layers 418 between separated layers of the wound cell 410.

The invention has been described using specific examples. The examples are intended to illustrate preferred embodiments of the invention and not to limit its scope.

1. An assembled linear stack of electrochemical cell members for a lithium-ion battery, the assembled linear stack comprising:
five to sixty lithium-ion cell, flat-layer, anode members, with opposing anode material layer faces, alternately interspersed in a linear stack with one less lithium-ion cell, flat-layer, cathode members with opposing cathode material layer faces, the flat-layer anode and cathode members having like face shapes, the face of each anode member being coextensively separated from the face of an adjacent cathode member in the linear stack by a porous separator layer member, each anode member comprising a copper foil or an aluminum foil current collector coated on both foil faces with a layer of porous lithium-ion cell anode material and each cathode member comprising an aluminum foil current collector layer coated on both foil faces with a layer of porous lithium-ion cell cathode material, the linear stack having a three-layer anode member at each end of the linear stack; the assembled linear stack further comprising a reference electrode assembly, inserted between an intermediate anode member and an otherwise adjoining intermediate cathode member within the linear stack between the first and second ends, each cell member being wetted with a non-aqueous liquid, lithium ion-containing electrolyte, the reference electrode assembly comprising:
a first porous separator layer member with opposing faces, one separator layer face co-extensively covering the layer of electrode material of one of the intermediate anode or cathode;
a single layer of opposing electrode material, with respect to the intermediate anode or cathode member, placed against the opposite face of the first porous separator layer member, the single layer of opposing electrode material being carried on a through-hole containing current collector foil;
a second porous separator layer with one face placed against the hole-containing current collector foil carrying the opposing electrode material;
a reference electrode comprising a layer of porous reference electrode material carried coextensively on one face of a non-porous current collector foil, the layer of porous reference electrode material being placed against the opposite face of the second porous separator layer, the reference electrode material comprising a porous particulate layer of one of lithium iron phosphate and lithium titanate; and
a third porous separator layer with one face placed against the hole-containing current collector foil carrying the reference electrode material, and the other face placed against the other of the intermediate anode or cathode member.

2. An assembled linear stack of electrochemical cell members for a lithium-ion battery as recited in claim 1 further comprising the porous reference electrode material being material carried coextensively on one face of a hole-containing porous current collector foil, an auxiliary reference electrode comprising a layer of porous auxiliary reference electrode material carried on one or both opposing faces of a non-porous current collector foil, a layer of porous auxiliary reference material being placed against the other face of the third porous separator layer, and
a fourth porous separator layer with one face placed against the auxiliary reference electrode and the other face placed against the other of the intermediate anode or cathode material.

3. An assembled linear stack of electrochemical cell members for a lithium-ion battery as recited in claim 1 in which the hole opening area of the hole-containing current collector foils is in the range of from about 0.01% to about 98% of the outline face area of the foil.

4. An assembled linear stack of electrochemical cell members for a lithium-ion battery as recited in claim 1 in which lithium iron phosphate reference electrode material is coated on one face of an aluminum current collector foil and the thickness of the coating of the lithium iron phosphate on a face of the aluminum current collector foil is in the range of 0.1 to 150 micrometers.

5. An assembled linear stack of electrochemical cell members for a lithium-ion battery as recited in claim 1 in which lithium titanate reference electrode material is coated on one face of an aluminum current collector foil and the thickness of the coating of the lithium titanate on a face of the aluminum current collector foil is in the range of 0.1 to 150 micrometers.

6. An assembled linear stack of electrochemical cell members for a lithium-ion battery as recited in claim 1 in which lithium titanate reference electrode material is coated on one face of a copper current collector foil and the thickness of the coating of the lithium titanate on a face of the copper current collector foil is in the range of 0.1 to 150 micrometers.

7. An assembled linear stack of electrochemical cell members for a lithium-ion battery as recited in claim 2 in which the pore or hole opening area of the porous aluminum current collector foil or porous copper current collector foil utilized in the reference electrode member is in the range of from about 0.01% to about 98% percent of the outline face area of the aluminum or the copper foil.

8. An assembled linear stack of electrochemical cell members for a lithium-ion battery as recited in claim 1 in which the thicknesses of the nonporous copper foils used as anode current collectors are in the range of about six to twenty micrometers and the thicknesses of the nonporous aluminum foils used as cathode current collectors are in the range of about ten to about thirty micrometers.

9. An assembled linear stack of electrochemical cell members for a lithium-ion battery as recited in claim 1 in which the electrode members and the separator members are in the form of flat layered structures which are rectangular in shape and the lengths of the sides of the rectangular layers are in the range of ten to five hundred millimeters.

10. An assembled linear stack of electrochemical cell members for a lithium-ion battery as recited in claim 1 in which the thicknesses of the coating layers of porous lithium-ion cell anode material and of porous lithium-ion cell cathode material are in the range of about ten to one hundred fifty micrometers.

11. An assembled linear stack of electrochemical cell members for a lithium-ion battery as recited in claim 1 in which the peripheral dimensions of the anode members are larger than the peripheral dimensions of the cathode members, and the peripheral dimensions of the separators are larger than the peripheral dimensions of the anode members.

12. An assembled linear stack of electrochemical cell members for a lithium-ion battery as recited in claim 1 in which each anode member contains an electrical conductor tab on its copper foil current collector which tabs are joined as a common anode group terminal member in the assembled unit, each cathode member comprises a conductor tab on its aluminum foil current collector which tabs are joined as a common cathode group terminal member in the assembled unit, and the reference electrode has a single conductor tab on its porous aluminum or copper current collector foil, such that the assembled unit presents three or more accessible members for electrical connection which extend from any container of the assembled unit.

13. An assembled linear stack of electrochemical cell members for a lithium-ion battery as recited in claim 1 in which the lithium iron phosphate reference electrode material is characterized by the formula, Li₍₁₋ₓ₎FePO₄, where x has a value in the range 0<x<1 such that the lithium iron phosphate material of the reference electrode of the cell maintains a flat voltage plateau when connected to an anode or cathode material of the electrochemical cell.

14. An assembled linear stack of electrochemical cell members for a lithium-ion battery as recited in claim 1 in which the lithium titanate reference electrode material is characterized by the formula, Li₍₄₊ₓ₎Ti₅O₁₂, where x has a value in the range 0<x<3 such that the lithium titanate reference material of the reference electrode of the cell maintains a flat voltage plateau when connected to an anode or cathode material of the electrochemical cell.

15. A battery pouch comprising an assembled linear stack of electrochemical cell members for a lithium-ion battery, the assembled linear stack comprising:
a predetermined number of lithium-ion cell, flat-layer, anode members, with opposing layer faces, interspersed in a first linear stack portion with an equal number of lithium-ion cell, flat-layer, cathode members with opposing layer faces, the flat-layer anode and cathode members having like face shapes, the face of each anode member being coextensively separated from the face of an adjacent cathode member in the first linear stack portion by a porous separator layer member, each anode member comprising a copper foil or an aluminum foil current collector coated on both foil faces with a layer of porous lithium-ion cell anode material and each cathode member comprising an aluminum foil current collector layer coated on both foil faces with a layer of porous lithium-ion cell cathode material, the first linear stack portion having a three-layer cathode member at a first end of the first linear stack portion and a three-layer anode portion at the opposite, second end of the first linear stack portion, the copper foil current collector of each anode member being connected to an anode group terminal and the aluminum foil current collector of each cathode member being connected to a cathode group terminal;
a porous separator layer member with opposing faces, one separator layer face co-extensively covering the layer of porous lithium-ion cell cathode material at the second end of the first linear stack portion and a two-layer lithium-ion cell anode member placed against the opposite face of the porous separator layer member, the two-layer lithium-ion cell anode member consisting of a porous layer of lithium-ion cell anode material carried on a porous copper foil, the anode material being placed against the opposite face of the separator layer, the porous copper foil of the two-layer anode member being connected to the anode group terminal; the assembled linear stack further comprising a reference electrode assembly, inserted between an intermediate anode member and an otherwise adjoining intermediate cathode member within the linear stack between the first and second ends, the reference electrode assembly comprising:
a first porous separator layer member with opposing faces, one separator layer face co-extensively covering the layer of electrode material of one of the intermediate anode or cathode;
a single layer of opposing electrode material, with respect to the intermediate anode or cathode member, placed against the opposite face of the first porous separator layer member, the single layer of opposing electrode material being carried on a through-hole containing current collector foil;
a second porous separator layer with one face placed against the hole-containing current collector foil carrying the opposing electrode material;
a reference electrode comprising a layer of porous reference electrode material carried coextensively on one face of a through-hole containing current collector foil, the layer of porous reference electrode material being placed against the opposite face of the second porous separator layer, the reference electrode material comprising a porous particulate layer of one of lithium iron phosphate and lithium titanate; and
a third porous separator layer with one face placed against the hole-containing current collector foil carrying the reference electrode material, and the other face placed against the other of the intermediate anode or cathode member;
the assembled linear stack with its reference electrode assembly being contained and sealed in an electrically insulated pouch with the anode group terminal, the cathode group terminal, and the reference electrode tab extending outside the battery pouch.

16. A battery pouch as recited in claim 15 in which the pouch container comprises polymer-coated aluminum foil with the polymer-coated aluminum foil pouch material fully enclosing the cell electrodes with only the anode group terminal, the cathode group terminal, and the tabs of the reference electrodes extending outside the battery pouch.

17. A battery pouch as recited in claim 16 in which the battery pouch is rectangular in shape and the reference electrode tabs are located at the same side of the pouch as the anode group terminal and the cathode group terminal.

18. A wound stack of four overlying, coextensive, linear electrochemical cell member strips for a lithium-ion battery, the wound stack having two ends formed by the overlying ends of the four strips, one stack end being located at the interior of the wound stack and the other stack end terminating at the outer surface of the wound stack, the four strips being characterized by;
a three-layer cathode strip comprising a porous layer of particles of cathode material bonded to each side of a non-porous current collector foil, a first porous separator strip placed against the layer of porous cathode material on one side of the cathode strip, a three-layer anode strip comprising a porous layer of particles of anode material bonded to each side of a non-porous current collector foil with one layer of anode material placed against the first porous separator strip, a second porous separator strip placed against the second layer of anode material, the second porous separator strip forming the inner surface of the wound stack and the cathode strip forming the outer surface of the wound stack; the wound stack further comprising a reference electrode assembly inserted against uncovered surfaces of the second porous separator strip at the inner end of the wound stack or at the outer end of the wound stack; the reference electrode assembly comprising:
a single layer of cathode electrode material placed against a portion of the uncovered surface of the second porous separator layer member of the wound stack, the single layer of cathode material being carried on a through-hole containing current collector foil;
a first porous separator layer of the reference electrode assembly with one face placed against the hole-containing current collector foil carrying the cathode material; and
a reference electrode comprising a layer of porous reference electrode material carried coextensively on one face of a through-hole containing current collector foil, the through-hole containing current collector foil being placed against the opposite face of the first porous separator layer of the reference electrode assembly, the reference electrode material comprising a porous particulate layer of one of lithium iron phosphate and lithium titanate, the layer of reference material being placed against a wound-over second portion of the second porous separator strip of the wound stack.

19. A wound stack of four overlying, coextensive linear electrochemical cell member strips for a lithium-ion battery as recited in claim 18 in which the reference electrode assembly further comprises a second porous separator layer of the reference electrode assembly with one face placed against the layer of porous reference electrode material, and an auxiliary reference electrode comprising a layer of porous auxiliary reference electrode material carried on one or both opposing faces of a non-porous current collector foil, a layer of porous auxiliary reference material being placed against the other face of the second porous separator layer of the reference electrode assembly, and
the other side of the auxiliary reference electrode being placed against a wound-over second portion of the second porous separator strip of the wound stack.

20. A wound stack of four overlying, coextensive linear electrochemical cell member strips for a lithium-ion battery as recited in claim 18 in which the hole opening area of the hole-containing current collector foils is in the range of from about 0.01% to about 98% of the outline face area of the foil.

21. A wound stack of four overlying, coextensive linear electrochemical cell member strips for a lithium-ion battery as recited in claim 18 in which lithium iron phosphate reference electrode material is coated on one face of a current collector foil and the thickness of the coating of the lithium iron phosphate on the face of the current collector foil is in the range of 0.1 to 150 micrometers.

22. A wound stack of four overlying, coextensive linear electrochemical cell member strips for a lithium-ion battery as recited in claim 18 in which lithium titanate reference electrode material is coated on one face of a current collector foil and the thickness of the coating of the lithium titanate on a face of the current collector foil is in the range of 0.1 to 150 micrometers.

23. A linear stack or a wound stack of containing at least one lithium or sodium anode and a complementary cathode with a porous separator layer interposed between each lithium or sodium anode and complementary cathode, the linear stack or wound stack serving as a source of electrochemical energy or as a capacitor, each anode comprising a metal foil current collector coated on both foil faces with a layer of porous lithium or sodium intercalating anode material and each cathode comprising a metal foil current collector coated on both foil faces with a layer of porous complementary cathode material, the linear or wound stack further comprising a reference electrode inserted between an anode and an adjacent cathode, each cell member being wetted with a non-aqueous liquid, lithium ion-containing, or sodium ion-containing electrolyte, the reference electrode comprising:
a first porous separator member with opposing faces, one separator layer face co-extensively covering the layer of one of an anode or cathode material;
a single layer of opposing electrode material, with respect to the anode or cathode material, placed against the opposite face of the first porous separator layer member, the single layer of opposing electrode material being carried on a through-hole containing current collector foil;
a second porous separator layer with one face placed against the hole-containing current collector foil carrying the opposing electrode material;
a reference electrode comprising a layer of porous reference electrode material carried coextensively on one face of a through-hole containing current collector foil, the layer of porous reference electrode material being placed against the opposite face of the second porous separator layer, the reference electrode material comprising a porous particulate layer of one of lithium iron phosphate and lithium titanate; and
a second porous separator layer with one face placed against the hole-containing current collector foil carrying the reference electrode material, and the other face placed against the other of the anode or cathode member.

24. A linear stack or a wound stack of containing at least one lithium or sodium anode and a complementary cathode with a porous separator layer interposed between each lithium or sodium anode and complementary cathode as recited in claim 23 further comprising an auxiliary reference electrode comprising a layer of porous auxiliary reference electrode material carried on one or both opposing faces of a non-porous current collector foil, one layer of porous auxiliary reference material being placed against the other face of the second porous separator layer, and
a third porous separator layer with one face placed against the auxiliary reference electrode and the other face placed against the other of the anode or cathode material.
